(19) United States
(12) Patent Application Publication
(10) Pub. No.: US 2006/0274601 A1
(43) Pub. Date: Dec. 7, 2006

(54) Prepacked cartridge mixing system

(76) Inventor: James P. Seaton JR., Chatham, NJ (US)

Correspondence Address: Melvin I. Stoltz, 51 Cherry Street, Milford, CT, 06460, US

(21) Appl. No.: 11/432,599

(22) Filed: May 11, 2006

Related U.S. Application Data
(60) Provisional application No. 60/688,555, filed on Jun. 7, 2005.

(51) Int. Cl. B01F 13/06

(52) U.S. Cl. 366/139

(57) ABSTRACT

By creating a single housing or member within which a two-component cement is pre-packaged and maintained separately until mixing is desired, a unitary, pre-packaged, easy to use, bone cement mixing and dispensing system is attained. Furthermore, the cement components are able to be easily combined and intermixed, with the single housing or member also been employed for delivering the mixed cement to the desired site. In addition, the entire mixing and dispensing system of the present invention employs a minimum number of components, thereby achieving a system capable of being produced at competitive prices.

### TECHNICAL FIELD

This invention relates to a system or apparatus for preparing and delivering polymeric cement made from at least two pre-packaged components and formulated for surgical applications such as vertebroplasty, Kyphoplasty, bone void filling, and securing prosthetic devices to bones and joints. In particular, the present invention enables the preparation and delivery of the polymeric cement in a single component which is then used for delivering the cement directly to the desired site.

### BACKGROUND ART

In many surgical procedures, particularly orthopedic surgery, it has become common to affix implants and/or artificial joints to bones or joint structures in order to improve the strength, rigidity, and movement of the bone/joint structure. Although such prosthetic devices have been widely used, joints are the most common examples of areas where prosthetic devices are used to reduce or eliminate pain and suffering that exist from typical leg movements.

As part of these operations, it has become common practice to secure the prosthesis to the bone or joint using a cement, formed by intermixing a powder and a liquid. Once intermixed, the two components must be thoroughly blended together to achieve the required consistency for the fully mixed cement, with the fully mixed cement then being loaded into a dispensing apparatus for placement in the desired area for affixing the prosthesis to the desired site.

In many applications, the two components forming the cement are mixed in a mixing vessel and, once fully mixed, are manually transferred from the mixing vessel to a dispensing member. Typically, devices such as caulking guns are employed, for dispensing the fully mixed cement to the precisely desired location of the patient. This process is extremely unpleasant for individuals mixing the cement, since the mixed cement contains an offensive, noxious odor. Furthermore, removal of the mixed cement from the mixing vessel into the caulking gun is cumbersome, time-consuming, and has the potential for being mishandled and/or dropped.

Another problem typically encountered with prior art systems is the difficulty encountered with air being entrapped in the mixed cement. The presence of air pockets or air bubbles in the mixed cement is undesirable. Since it is important that the cement added to the bone area for affixing the prosthesis be virtually free of any entrapped air bubbles or air pockets, most prior art systems demand mixing of the powder and liquid under vacuum conditions. As a result, added limitations are incurred on the flexibility of the mixing vessel and the ability to mix the two-part cement mixture in any desired location.

Although attempts have been made to reduce or eliminate some of these prior art problems, no prior art system has been developed which completely eliminates all of the difficulties and drawbacks that have been found with these prior art systems. Although some prior art systems have been developed which enable the mixing to be performed in the same vessel which is employed for feeding the mixed cement to the patient, these prior art systems are typically complex and difficult to operate. Furthermore, numerous, small components are employed in these prior art systems, requiring expensive assembly and manufacturing costs. In addition, many of these prior art systems also require one component of the two-part cement mixture to be manually added, thereby adding complexity and difficulty to the overall system.

Therefore, it is a principal object of the present invention to provide a unitary bone cement mixing and dispensing system which comprises a fully integrated structure and eliminates the need for independent, manual transfer of components to the system.

Another object of present invention is to provide a unitary bone cement mixing and dispensing system having the characteristic features described above, which is easy to use and provides a simple, straightforward operation.

Another object of the present invention is to provide a unitary bone cement mixing and dispensing system having the characteristic features described above, which provides intermixed bone cement virtually devoid of entrapped air pockets or air bubbles, while also substantially reducing or minimizing the need for mixing under vacuum.

Another object of the present invention is to provide a unitary bone cement mixing and dispensing system having the characteristic features described above, which is easily any individual, and virtually eliminates unwanted odors and product handling difficulties.

Other and more specific objects will impart the obvious and will in part appear hereinafter.

### SUMMARY OF THE INVENTION

By employing the present invention, all of the difficulties and drawbacks encountered with prior art systems are substantially eliminated and a unitary, pre-packaged, easy to use, bone cement mixing and dispensing system is attained. This unique achievement is realized by creating a single housing or member within which the two-component cement is pre-packaged and maintained separately until mixing is desired. Furthermore, the cement components are able to be easily combined and intermixed, with the single housing or member also been employed for delivering the mixed cement to the desired site. In addition, the entire mixing and dispensing system of the present invention employs a minimum number of components, thereby achieving a system capable of being produced at competitive prices.

In the present invention, a single, elongated, substantially cylindrically shaped tubular member is employed which is open at one end thereof, with the opposed end being partiallly closed and incorporating an outlet portal. In addition, the bone cement mixing and dispensing system of the present invention also incorporates a mixing element, which is axially movable within said tubular member and is constructed to provide thorough and complete intermixinig of the components forming the bone cement. In addition, the mixing element preferably cooperates with a movable disc which incorporates a plurality of piercing elements. Finally, a cylindircal/toroidal shaped monomer holding and dispensing vessel is also noted in the tubular member, positioned for cooperating with the movable disc. By employing these components, along with an elongated handle member, a bone cement mixing and dispensing system is realized which is capable of overcoming virtually all of the prior art difficulties and drawbacks.

In most applications, the two-component bone cement comprises a dry, powder component and a liquid monomer component. When these two components are combined and thoroughly intermixed with each other, the desired polymeric cement is obtained. In the present invention, the dry, powder component is retained and stored in the cylindrically shaped tubular member, while the liquid monomer component is stored in the cylindrical/toroidal holding and dispensing vessel.

In the preferred embodiment, the cylindrical/toroidal holding and dispensing vessel incorporates a cavity or holding zone formed therein within which the liquid monomer is retained. The holding zone is sealed for securely retaining the liquid monomer until the seal is ruptured, preferably by the piercing elements of the movable disc, allowing the monomer to be delivered to the powdered component for intermixing therewith. In addition, the cylindrical/toroidal holding and dispensing vessel is preferably constructed for effectively sealing the open end of the cylindrically shaped tubular member for enabling the two components, when combined, to be easily intermixed with each other, without having any unwanted air mixed therein.

Furthermore, in the preferred embodiment of the present invention, the cylindrical/toroidal shaped holding and dispensing vessel is constructed for being telescopically or axially movable along the length of the tubular member after the two components forming the cement have been thoroughly intermixed. Consequently, the cylindrical/toroidal holding and dispensing vessel functions as a piston for forcing the mixed bone cement through the cylindrically shaped tubular member for being dispensed through the portal formed at the opposed end thereof. In this way, the number of components required for forming the mixing and dispensing system of the present invention are substantially reduced and easy, rapid assembly of the system is realized.

In order to achieve thorough and complete intermixing of the components which form the bone cement, a mixing element is employed which is preferably mounted to one end of an elongated shaft for enabling the mixing element to be easily telescopically moved longitudinally along the length of the tubular member. By repeated axial movement of the elongated shaft, the mixing element is able to achieve the desired thorough mixing of the components of the bone cement.

Although a wide variety of alternate configurations can be employed, in the preferred embodiment, the mixing element comprises a circular shaped support base or ring on which a plurality of arm members or plates are mounted. In the preferred construction, each arm member or plate comprises a truncated triangular shape with an open central zone. Furthermore, each arm member of plate extends radially inwardly from the outer ring, meeting at the central axis of the ring.

In addition, a threaded bearing post is formed at the central axis of the base or juncture of the arm member plates, extending therefrom in a direction opposite from the arm members/plates. This threaded cavity bearing post is constructed for mating threaded interengagement with the distal end of the elongated shaft or handle member, thereby enabling the mixing element to be easily moved through the tubular member.

By empoying this construction, the handle member is quickly and easily mounted to the mixing element for providing the desired mixing agitation of the components of the bone cement. Then, once the cement has been thoroughly intermixed, the handle can be quickly and easily removed by disengaging the threaded end of the handle from the post of the mixing element.

As a further feature of the present invention, a circular shaped disc is mounted in the tubular member between the mixing element and the holding and dispensing veseel. In its preferred construction, the disc incorporates a plurality of piercing or lancing elements formed thereon positioned for piercing the seal member of the cylindrical/toroidal holding and dispensing vessel. Preferably, the lancing elements incorporate passageways formed therein to enable the monomer to flow freely from the holding and dispensing vessel into the tubular member.

In this way, the liquid monomer contained within the holding and dispensing vessel is securely retained therein until the user draws the surface of the disc bearing the lancing elements into contact with the seal, rupturing the seal and enabling the monomer to drain into the dry powdered component. With the lanching elements incorporating passageways formed therein, the desired transfer of the monomer to the dry powder is assured. Once fully dispensed, the two components are combined and are able to be thoroughly intermixed.

The invention accordingly comprises the features of construction, combination of elements, and arrangement of parts which will be exemplified in the construction hereinafter set forth, and the scope of the invention will be indicated in the claims.

### THE DRAWINGS

For a fuller understanding of the nature and objects of the invention, reference should be had to the following detailed description taken in connection with the accompanying drawings, in which:

FIG. 1 is an exploded perspective view of the bone cement mixing and dispensing system of the present invention;

FIG. 2 is a side elevation view of the bone cement mixing and dispensing system of FIG. 1, fully assembled, with all of the components shown in cross-section;

FIG. 3 is an exploded, cross-sectional, perspective view of the cylindrical/toroidal holding and dispensing vessel forming a component of the mixing and dispensing system of the present invention;

FIG. 4 is a cross-sectional side elevation view, partially broken away, of the holding and dispensing vessel and associated components of the mixing and dispensing system of the present invention employed to dispense the monomer from the holding and dispensing vessel;

FIG. 5 is a cross-sectional side elevation view of the bone cement mixing and dispensing system with the bone cement in the process of being fully mixed for use;

FIG. 6 is a top plan view of the mixing element forming one component of the bone mixing and dispensing system of the present invention; and

FIG. 7 is a cross-sectional side elevation view of the mixing element of FIG. 6 taken along line 7-7 of FIG. 6.

### DETAILED DISCLOSURE

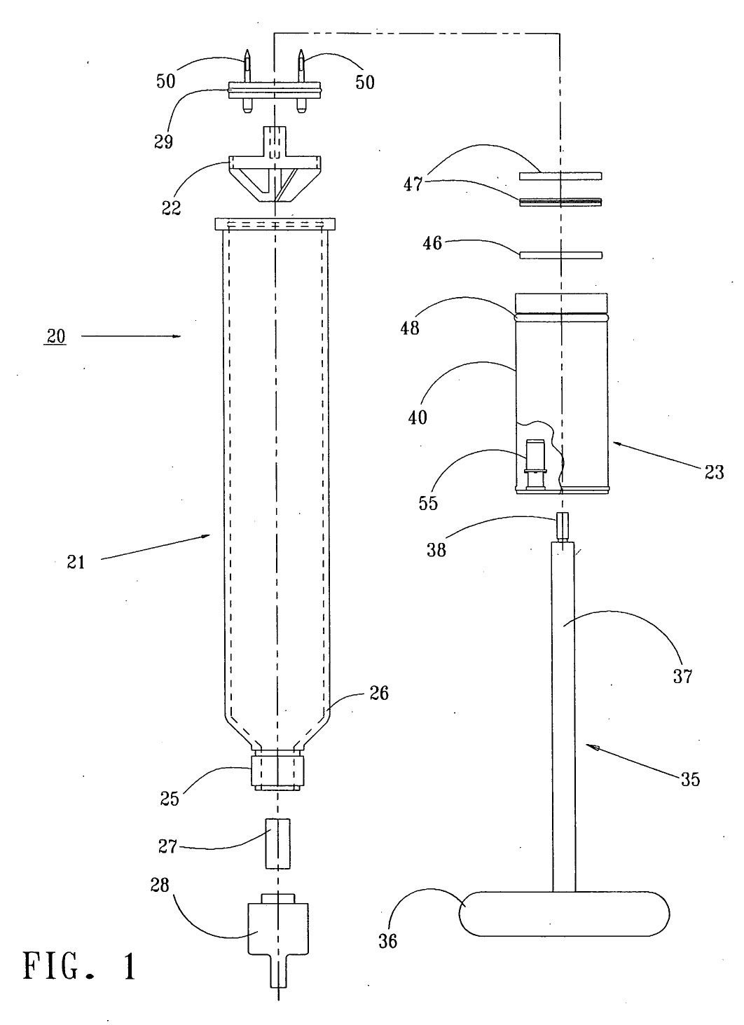

By referring to FIGS. 1-7 along with the following detailed discussion, the construction and operation of the preferred embodiment of the bone cement mixing and dispensing system of the present invention can best be understood. In addition, in FIGS. 1-7, the preferred embodiment of the present invention is fully detailed. However, alternate constructions can be implemented without departing from the scope of the present invention. Consequently, it is to be understood that the following detailed disclosure and the embodiment shown in FIGS. 1-7, are provided for exemplary purposes only and are not intended as a limitation of the present invention.

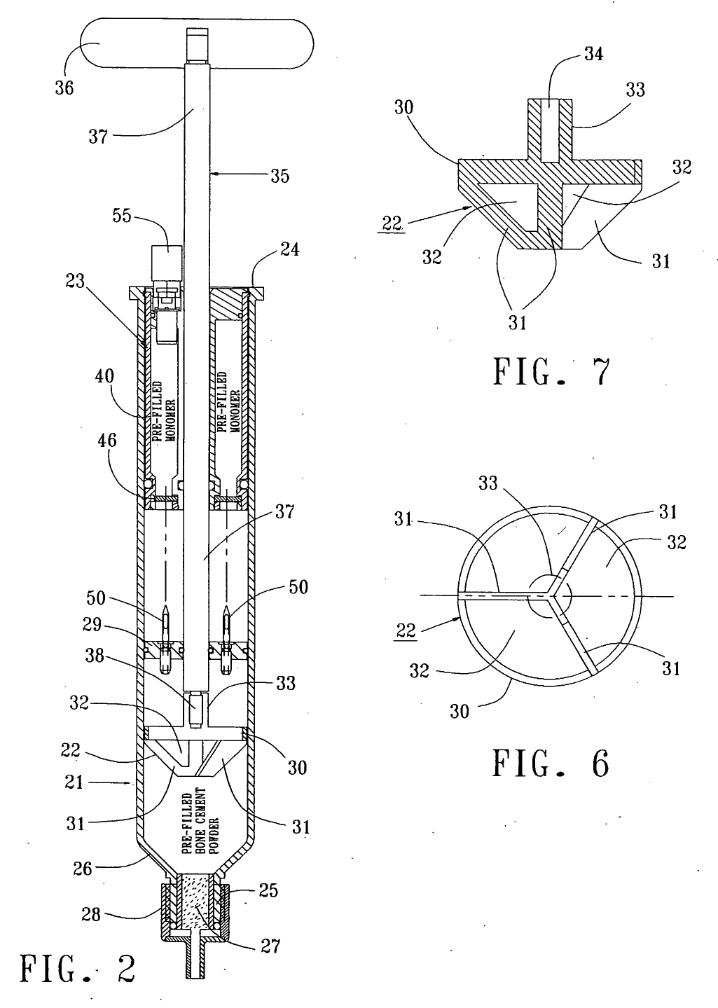

As best seen in FIGS. 1 and 2, bone cement mixing and dispensing system 20 of the present invention incorporates substantially cylindrically shaped, tubular member 21 in combination with mixing element 22 and cylindrical or toroidal shaped holding and dispensing vessel 23, circular shaped disc 29, and elongated shaft or drive member 35. By employing these limited, principal components, highly effective cement mixing and dispensing system 20 of the present invention is achieved which provides the desired thorough, uniform, rapid intermixing of the bone cement components, as well as the delivery of the mixed bone cement to the precisely desired site, using this single, unitary product. In this way, all of the goals and objectives of the present invention are achieved.

In its preferred construction, tubular member 21 incorporates open end 24, opposed partially closed end 26, and outlet portal 25 formed on end 26. In the preferred construction, outlet portal 25 incorporates a threaded outer surface for enabling adapter 27 to be affixed thereto, effectively closing and sealing tubular member 21. In addition, as further discussed below, the threaded outer surface of outlet portal 25 enables adapter 28 to be mounted thereto, for enabling a vacuum source to be interconnected to system 20, as well as enabling the cement to be delivered directly to the desired site.

As is evident from the following detailed discussion, the components forming cement mixing and dispensing system 20 cooperate to achieve an easily constructed and easily employed, fully integrated system which requires a minimum number of components. In addition, system 20 is capable of maintaining the ingredients forming the bone cement completely separate during shipping and storage, while also providing for the rapid combination of these ingredients, whenever desired, as well as the thorough intermixing thereof. Furthermore, the construction of the present invention also provides an effective delivery system which is fully integrated into the system and achieves the dispensing of the fully intermixed bone cement through the exit portal to the desired site. In this way, all of the difficulties and drawbacks found in prior art constructions are completely eliminated, and the highly effective, price competitive, easily employed cement mixing and dispensing system is realized.

One of the principal components forming cement mixing and dispensing system 20 is mixing element 22, which is mounted to threaded end 38 of elongated shaft 37 of drive member 35. In its preferred construction, as best seen in FIGS. 6 and 7, mixing element 22 comprises substantially circular shaped support base or ring 30 to which a plurality of arm members or plates 31 are mounted. In this construction, each arm member/plate comprises a truncated triangular shape with an enlarged aperture or open zone 32 formed therein. In addition, each arm member/plate extends radially inwardly from ring 30 to a single juncture point which forms the center of mixing element 22.

Finally, post or boss 33 is formed at the juncture of arm members/plates 31 at the central axis of mixing element 22, with boss/post 33 extending from base or ring 30 in a direction opposite from the direction of arm members/plates 31. In addition, threaded cavity 34 is formed in boss/post 33, constructed for receiving and being threadedly engaged with threaded terminating end 38 of shaft 37 or drive member 35.

As a result of this construction, mixing element 22 incorporates a plurality of apertures or open zones 32 through which the bone cement is capable of flowing as mixing element 22 is axially advanced through cylindrically shaped tubular member 21 for causing the thorough intermixing of the components which forms the bone cement. As detailed above, apertures or open zones 32 are formed in each arm member or plate 31, with additional apertures or open zones 32 also being formed between the adjacent sides of arm members/plates 31 as they extend from base or ring 30 inwardly to the central axis. In this way, optimum mixing and stirring of the bone cement during the formation process is achieved.

As mentioned above, in order to enable the user to move mixing element 22 axially through tubular member 21, to provide the desired thorough intermixing of the components forming the bone cement, bone cement mixing and dispensing system 20 of the present invention incorporates drive member 35 which comprises handle 36 and shaft 37. In addition, shaft 37 incorporates a threaded terminating end 38 which is constructed for mating, threaded interengagement with threaded cavity 34 of post/boss 33 of mixing element 22. In this way, once drive member 35 is threadedly interconnected with mixing element 22, the user is able to axially drive mixing element 22 through the elongated length of tubular member 21, fully and completely intermixing the components forming the desired bone cement.

In addition, as shown in FIGS. 1, 2, 4 and 5, system 20 also preferably incorporates disc 29 mounted in tubular member 21 for axial movement therein. In its preferred constructio0n, disc 29 comprises a circular shape, is mounted about shaft 37 and is positioned between mixing element 22 and holding and dispensing vessel 23. Furthermore, disc 29 incorporates a plurality of upstanding needles, piercing or lancing elements 50 mounted to the surface thereof, facing cylindrical/toroidal holding and dispensing vessel 23.

As is more fully detailed below, needles, piercing or lancing elements 50 are positioned and constructed for rupturing the seal member formed on cylindrical/toroidal holding and dispensing vessel 23 which retains the liquid monomer therein prior to its use. In its preferred construction, piercing/lancing elements 50 incorporate longitudinally extending passageways 51 formed therein. In this way, when the mixed bone cement is to be prepared for use, the monomer contained in cylindrical/toroidal holding and dispensing vessel 23 is quickly and easily transferred through passageway 51 of piercing/lansing elements 50 into tubular member 21 for being combined with the dry powder retained therein.

By referring to FIG. 3, the preferred construction of cylindrical/toroidal holding and dispensing vessel 23 can best be understood. As shown therein, holding and dispensing vessel 23 comprises outer surface 40 and inside surface 41 which defines a cylindrically shaped passageway 42 which extends the entire length of holding and dispensing vessel 23. As is evident from the foregoing detailed discussion, cylindrical passageway 42 enables shaft 37 of drive member 35 to be inserted into tubular member 21 and threadedly engaged with mixing element 22. In addition, passageway 42 also enables shaft 37 of drive member 35 to be axially moved through tubular member 21. In this regard, in order to prevent, or substantially reduce, any unwanted air flow into tubular member 21, O-ring seal 43 is mounted in wall 41 of passageway 42 for cooperative engagement with shaft 37.

Holding and dispensing vessel 23 also incorporates closed end, cylindrically shaped, internal cavity or holding zone 45 which is formed between outer wall 40 and inside wall 41. Cavity/holding zone 45 is constructed for retaining the liquid monomer and securely sealing the liquid monomer separately and independently from the powdered component of the bone cement, until the use of the liquid monomer is desired for being intermixed with the powdered component. In order to achieve this desired separation, cavity/holding zone 45 is closed at one end by terminating wall 44 of holding and dispensing vessel 23, while the opposed end of cavity/holding zone 45 is closed by a seal member 46.

Seal member 46 may comprise a wide variety of alternate constructions. In this regard, seal member 46 may be formed, as shown, with a plurality of layers consisting of aluminum foil with or without plastic coatings, and plastic based layers such as urethane, polypropylene, silicone, polytetra-fluoroethylene, and the like. In addition, if desired, seal member 46 may be formed from rubber or urethane material, such as employed in conventional septa seals. However, regardless of the configuration employed for seal member 46, seal member 46 is mounted to holding and dispensing vessel 23, completely closing cavity/holding zone 45 and securely retaining the liquid monomer therein until its use is desired.

In addition, seal 46 is also constructed to be penetrated or ruptured by piercing or lancing elements 50 and, once piercing/lancing elements 50 are engaged therewith, the transfer of the liquid monomer from holding zone 45 into the interior of tubular member 21 is easily realized by passage of the monomer through passageways 51 formed in piercing or lancing elements 50.

Additional elements preferably incorporated into cylindrical/toroidal holding and dispensing vessel 23 are holding rings 47 and outer seal 48. Holding rings 47 are constructed for securely maintaining seal 46 in position and assuring that a completely sealed surface is realized. Rings 47 are preferably constructed from steel and are spring biased to lock in place, securing seal 46 in the precisely desired location by peripherally surrounding and contacting the top surface of seal 46, while also defining an enlarged passageway through which the piercing elements 50 of disc 29 easily pass for reaching seal 46.

Outer seal 48 may be formed in a wide variety of alternate constructions. In particular, outer seal 48 may be configured with an enlarged scraping surface for both sealing the outer surface of holding and dispensing vessel 23 with the inside surface of tubular member 21, while also providing a surface scraping function for removing any cement material adhered to the inside surface of tubular member 21. Alternatively, if desired, a generally conventional O-ring seal may be employed which is constructed for providing the desired air impervious seal, while also providing sufficient material for scraping the inside walls of tubular member 21 to remove any cement material therefrom.

Finally, holding and dispensing vessel 23 comprises valve 55 preferably mounted in end wall 44. As detailed below, valve 55 enables the interior of holding zone 45 to be exposed to ambient conditions, when required, thereby assisting in the rapid delivery of the monomer to tubular member 21. Alternatively, if desired, a plug or cap can be employed as a substitute for valve 55.

Typically, bone cement mixing and dispensing system 20 of the present invention is sold and distributed as a fully prepackaged, ready to use system, substantially as depicted in FIG. 2. In this regard, system 20 is retained in sealed and sterilized packaging and sold with the powdered component of the bone cement retained inside tubular member 21, while the liquid monomer component is retained in sealed confinement within cavity 45 of cylindrical/toroidal shaped holding and dispensing vessel 23. In addition, drive member 35 is mounted to mixing element 22 in order to enable drive member 35 and mixing element 22 to be ready for use. Furthermore, disc 29 with piercing elements 50 is mounted about shaft 37 of drive member 35, in a manner which enables shaft 37 to be axially moved therethrough, thereby assuring that mixing element 22 is freely movable along tubular member 21.

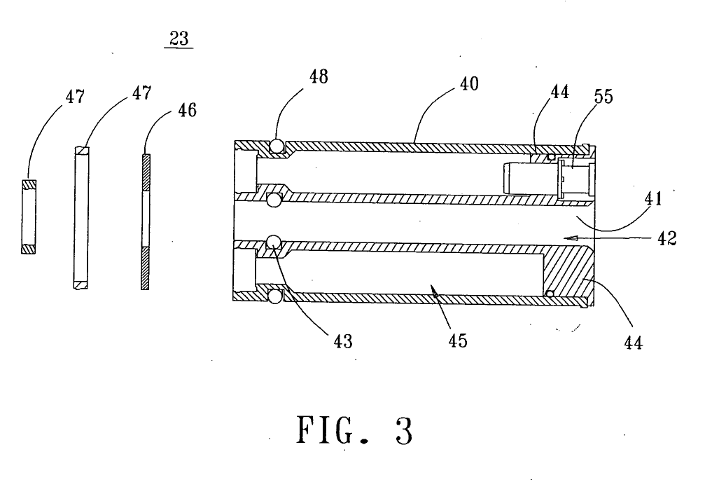

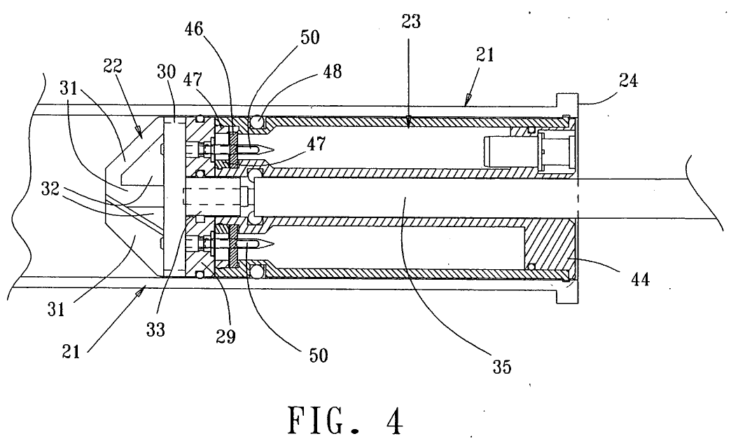

If desired, a lock member can be employed to secure drive member 35 in a fixed position prior to its use. In addition, as further discussed below, shaft 37 may incorporate score lines formed therein, as shown in FIG. 4, for enabling shaft 37 to be broken for complete removal, after final use.

Finally, the distal end of tubular member 21 may be sold with a cap affixed to threaded outlet portal 25 of end 26. Preferably, however, adapter 28 is mounted to the threaded end of outlet portal 25, for connection to a vacuum source, with the interior exit portal 25 being filled with filter member 27.

Whenever a user wishes to employ bone cement mixing and dispensing system 20 of the present invention, system 20 is removed from the sterilized packaging in which system 20 is retained. Thereafter, the user grabs handle 36 of drive member 35 and axially draws mixing element 22 upwardly through tubular member 21 into contact with disc 29. Then, mixing element 22 and disc 29 are drawn upwardly until piercing/lancing elements 50 are brought into piercing engagement with seal 46 of holding and dispensing vessel 23.

Once piercing elements 50 have been drawn through seal 46, the liquid monomer contained in holding zone 45 of holding and dispensing vessel 23 is transferred through the passageways 51 formed in piercing elements 50 into the powdered cement component contained within tubular member 21. Alternatively, seal 46 may be constructed to rupture in its entirety, when pierced by elements 50 so as to enable the liquid monomer to flow out of holding zone 45 into tubular member 21.

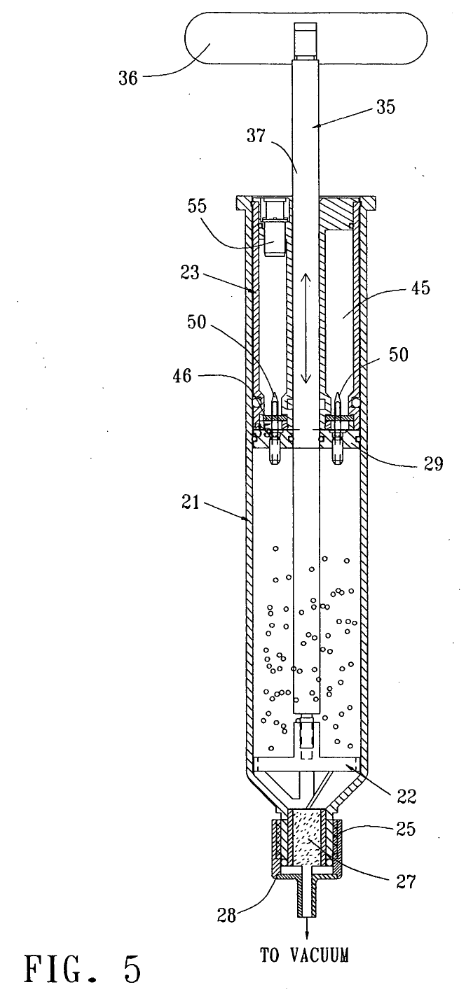

In the preferred embodiment, as clearly depicted in FIG. 5, seal member 46 is constructed to be employed in combination with piercing elements 50 which incorporate passageways 51 formed therein. In this way, the liquid monomer passes through interior passageways 51 formed in piercing elements 50 and drains into the powdered component of the cement contained within tubular member 21. In order to further enhance the free flow of the monomer, holding and dispensing vessel 23 preferably incorporates valve 55 mounted in end wall 44 thereof. By opening valve 55, or removing an equivalent cap or plug, the interior cavity or holding zone 45 is vented to atmosphere, thereby assuring the free flow of the monomer. This flow is further enhanced when adapter 28 is connected to a vacuum source. Once activated, the liquid monomer previously housed within holding zone 45 is effectively transferred from holding zone 45 into the interior of tubular member 21 wherein the liquid monomer and the powdered components are combined. Once the transfer is completed, valve 55 is closed for mixing of the components under vacuum conditions.

Furthermore, as clearly depicted in FIGS. 6 and 7, and discussed above, mixing element 22 is constructed with a plurality of enlarged holes or apertures 31 formed therein. In this way, the passage of the liquid monomer from holding zone 45 of holding and dispensing vessel 23 into the interior of tubular member 21 is assured, and the desired combination of the liquid monomer component with the powdered component of the bone cement is attained.

The next step in fully preparing the bone cement for use is the thorough mixing of the two components to form the bone cement. As shown in FIG. 5, by employing bone cement mixing and dispensing system 20 of the present invention, the thorough intermixing of these two components is quickly and easily attained by axially advancing and withdrawing drive member 35 substantially along the entire length of tubular member 21. In the preferred embodiment, the mixing chamber is exposed to the vacuum source in order to prevent air entrapment.

By repeatedly pushing handle 36 of drive member 35 downwardly in order to cause arm members/plates 31 of mixing element 22 to be forced toward end 26 of tube member 21, followed by drawing handle 36 of drive number 35 in the opposite direction causing arm members/plates 31 to be drawn upwardly toward cylindrical/toroidal holding and dispensing vessel 23, the components forming the bone cement are continuously and vigorously intermixed with each other. This intermixing is promoted by the construction of mixing element 22 with enlarged apertures 32 formed therein, and further enhanced by rotating drive member 35 during teach axial stroke. Typically, by repeatedly moving mixing element 22 through tubular member 21 for between about 30 and 45 seconds, the thorough intermixing of the components forming the bone cement is attained and bone cement ready for delivery to the patient is realized.

Once the bone cement is thoroughly mixed and ready for delivery to the patient, drive member 35 is drawn upwardly causing mixing element 22 to be brought into engagement with disc 29 and rings 47 of cylindrical/toroidal holding dispensing vessel 23, as shown in FIG. 5. In addition, in this position, post/boss 33 of mixing element 22 engages and effectively seals passageway 42 of mixing and dispensing vessel 23. As a result, entry of the mixed bone cement into passageway 42 is prevented. Once mixing element 22 is effectively engaged with disc 29 and holding and dispensing vessel 23 as detailed above, drive member 35 is disengaged from mixing element 22 by rotating drive member 35 to separate the threaded engagement of threaded end 38 of drive member 35 from the threaded cavity 34 of mixing element 22.

In this regard, the ends of piercing elements 50 extending from disc 29 are able to contact arm members/plates 31 to prevent rotation of mixing element 22, thereby enabling shaft 37 to be disengaged from mixing element 22. Alternatively, as mentioned above and shown in FIG. 4, shaft 37 may incorporate a score line or scored section to enable shaft 37 to be completely broken adjacent the end of vessel 23 for allowing a portion of shaft 37 and handle 36 to be easily discarded. Once drive member 35 has been completely removed from bone cement mixing and dispensing system 20, cement mixing and dispensing system 20 is ready for use to deliver the thoroughly mixed bone cement to the patient. In this regard, the first step in delivering the bone cement to the patient is to disconnect any vacuum source mounted to adapter 28, or alternatively, mount adapter 28 to portal 25 if not previously mounted thereto. However, prior to removing the vacuum pump, or other vacuum source from adapter 28, it is preferable to allow the vacuum to remain for several minutes in order to remove any air entrapped in the cement.

Thereafter, with the vacuum source removed, the entire bone cement mixing and dispensing system 20 is placed in a conventional delivery gun, typically employed in surgical procedures, whereby a drive member is positioned in contact with the rear end of cylindrical/toroidal holding and dispensing vessel 23, for advancing cylindrical/toroidal holding and dispensing vessel 23 and interconnected mixing element 22 inwardly along tubular member 21. This enables movement holding and dispensing vessel 23 and mixing element 22 to function as a piston to force the mixed bone cement through tubular member 21 and cause the bone cement to be forced through adapter 28 in the outlet portal thereof for delivery to the patient.

In addition, due to the construction of arm members/plates 31 of mixing element 22, effective engagement of mixing element 22 with end 26 of tubular member 21 is provided along witih the force delivery of the mixed bone cement thereof. In this way, a highly effective, mixing and delivery system is realized which is capable of providing thoroughly mixed bone cement in an easily employed and easily constructed product, as well as the delivery of the mixed bone cement to the desired site. In this preferred construction, adapter 28 incorporates filters, such as charcoal and foam, in order to further enhance the cement being delivered to the patient.

It will thus be seen that the objects set forth above, among those made apparent from the preceding description, are efficiently attained and, since certain changes may be made in the above construction without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described my invention, what I claim as new and desire to secure by Letters Patent is:

1. A bone cement mixing and dispensing system constructed for separately storing first and second components forming the bone cement and for providing intermixing of the said first and second components to produce the desired bone cement, said system comprising:
A. an elongated, substantially hollow cylindrically-shaped member comprising a first open end, a partially closed second end incorporating an exit portal formed therein, and a first component storage zone;
B. a holding chamber
a) dimensioned for mounted engagement in the cylindrical member,
b) constructed for sealingly retaining the second component of the bone cement therein, and
c) incorporating sealing means formed on one end of the holding chamber for providing sealed retention of the second component under a first condition and release of the second component for delivery into the cylindrical member under a second condition;
C. an elongated shaft mounted in the hollow cylindrical member, extending through the holding chamber, and constructed for being axially movable relative to the cylindrical member and the holding chamber; and
D. a mixing element mounted to a first end of the elongated shaft and responsive to the axial movement of the elongated shaft for providing thorough and complete stirring and intermixing of the first component and the second component when said components are combined in the cylindrical member, for producing the desired bone cement composition;
whereby the components forming the bone cement are separately stored and thoroughly intermixed in a single housing for forming the desired bone cement, while also being able to be dispensed to the desired site from said housing.

2. The bone cement mixing and dispensing system defined in claim 1, wherein the second end of the hollow cylindrical member is further defined as being defined by a sloping, conically shaped wall extending from the outside edge of the hollow cylindrical member and terminating with the exit portal, whereby a generally convex shaped terminating end is realized for enhancing and controlling the flow of the mixed bone cement from the interior of the hollow cylindrical member through the exit portal.

3. The bone cement mixing and dispensing system defined in claim 2, wherein said system further comprises:
E. a movable plate slidingly mounted in the elongated hollow cylindrical member for axial movement therein, said plate incorporating a plurality of piercing elements mounted thereto, said piercing elements incorporating passageways formed therein and positioned for cooperating engagement with the sealing means of the holding chamber, whereby movement of said plate into engagement with the holding chamber causes said piercing elements to penetrate the sealing means thereof for enabling the second component to be transferred through the piercing elements into the cylindrical member.

4. The bone cement mixing and dispensing system defined in claim 3, wherein the holding chamber is further defined as comprising a generally toroidal or cylindrical shape having an a side wall member which comprises an outer diameter generally equivalent to the inner diameter of the hollow cylindrical member, with said side wall member being constructed for sealingly engaging the inner wall of said hollow cylindrical member while also being slidingly movable relative thereto, whereby axial movement of the holding chamber through the hollow cylindrical member causes the mixed bone cement to be forced through the exit portal.

5. The bone cement mixing and dispensing system defined in claim 4, wherein the holding chamber incorporates a central passageway formed therein which cooperates with the side wall member to define a retaining zone therebetween for the second component, said retaining zone being sealingly established by an end cap extending between the side wall member and the passageway at the first end of the holding chamber and said sealing means extending between the side wall member in the passageway at the second end of the holding chamber.

6. The bone cement mixing and dispensing system defined in claim 5, wherein the sealing means is a further defined as comprising a flexible membrane capable of closing and sealingly retaining the second component of the bone cement in the holding zone of the holding chamber, while also allowing piercing elements to penetrate said membrane without rupture thereof.

7. The bone cement mixing and dispensing system defined in claim 6, wherein said flexible membrane is further defined as sealingly engaging about said piercing elements for preventing unwanted leakage of the second component, thereby limiting transfer of the second components through said piercing elements.

8. The bone cement mixing and dispensing system defined in claim 7, wherein said flexible membrane is further defined as comprising gasket material consisting of one or more selected from the group consisting of polytetra-fluoroethylene, aluminum, silicone, and combinations thereof.

9. The bone cement mixing and dispensing system defined in claim 8, wherein said holding chamber further comprises valve means formed in the end cap and constructed for enabling the sealed holding chamber to be exposed to ambient conditions, thereby enabling the second components of the bone cement retained a therein to freely flow through the passageways of the piercing elements.

10. The bone cement mixing and dispensing system defined in claim 3, wherein said mixing element is further defined as comprising a support base or ring constructed for axial, sliding movement along the inside walls of the elongated hollow cylindrical member and a post member mounted to a first side of the support base/ring and incorporating a threaded zone formed therein, said threaded zone being constructed of for threaded interengagement with a first end of the elongated shaft, whereby axial movement of the elongated shaft relative to the cylindrical member simultaneously causes movement of said mixing element.

11. The bone cement mixing and dispensing system defined in claim 10, wherein said mixing element is further defined as comprising a plurality of arm or blade members mounted to a second side of the support base/ring of the mixing element in spaced relationship to each other, with each of said arm/blade members being formed in a ramped or sloping configuration with open zones formed therebetween for providing thorough intermixing and stirring of the components forming the bone cement while also providing for nested, contacting engagement with the convex wall of the second end.

12. The bone cement mixing and dispensing system defined in claim 11, wherein each of the arm/blade members of the mixing element are further defined as comprising a truncated triangular shape intersecting with each other at the center of the support base/ring, thereby further enhancing the thorough stirring and intermixing of the components forming the bone cement.

13. The bone cement mixing and dispensing system defined in claim 11, when the mixing element further comprises open zones formed therein for assuring passage of the mixing element through the bone cement and enhancing the thorough mixing thereof.

14. The bone cement mixing and dispensing system defined in claim 9, wherein said system further comprises an adapter mountable to the exit portal of the second end of the cylindrical member, said adapter being interconnectable to a vacuum source for exposing the the interior of the cylindrical member to vacuum whenever desired, thereby assuring the rapid transfer of the second component from the holding chamber through the piercing elements into the first complement retained in the cylindrical member, as well as providing for removal of any entrapped air from the bone cement during mixing.

15. The bone cement mixing and dispensing system defined in claim 14, wherein said exit portal is further defined as incorporating filter means mounted therein for preventing unwanted transfer of any mixed bone cement through the exit portal, while providing for the free flow of air through the exit portal to the vacuum.

16. A bone cement mixing and dispensing system constructed for separately storing first and second components forming the bone cement and for providing intermixing of the said first and second components to produce the desired bone cement, said system comprising:
A. an elongated, substantially hollow cylindrically-shaped member comprising a first open end, a partially closed second end incorporating an exit portal formed therein, and a first component storage zone;
B. a holding chamber
a) dimensioned for mounted engagement in the cylindrical member and comprising a generally toroidal or cylindrical shape having an a side wall member which comprises an outer diameter generally equivalent to the inner diameter of the hollow cylindrical member, with said side wall member being constructed for sealingly engaging the inner wall of said hollow cylindrical member while also being slidingly movable relative thereto, whereby axial movement of the holding chamber through the hollow cylindrical member causes the mixed bone cement to be forced through the exit portal,
b) constructed for sealingly retaining the second component of the bone cement therein, and
c) incorporating sealing means formed on one end of the holding chamber for providing sealed retention of the second component under a first condition and release of the second component for delivery into the cylindrical member under a second condition;
C. an elongated shaft mounted in the hollow cylindrical member, extending through the holding chamber, and constructed for being axially movable relative to the cylindrical member and the holding chamber; and
D. a mixing element mounted to a first end of the elongated shaft and responsive to the axial movement of the elongated shaft for providing thorough and complete stirring and intermixing of the first component and the second component when said components are combined in the cylindrical member, said mixing element comprising
a) support base or ring constructed for axial, sliding movement along the inside walls of the elongated hollow cylindrical member,
b) a plurality of arm or blade members mounted to the support base/ring of the mixing element in spaced relationship to each other, with each of said arm/blade members being formed in a ramped or sloping configuration with open zones formed therebetween for providing thorough intermixing and stirring of the components forming the bone cement while also providing for nested, contacting engagement with the convex wall of the second end, and
c) a post member mounted to the support base/ring and incorporating a threaded zone formed therein, said threaded zone being constructed of for threaded interengagement with a first end of the elongated shaft, whereby axial movement of the elongated shaft relative to the cylindrical member simultaneously causes movement of said mixing element; and
E. a movable plate slidingly mounted in the elongated hollow cylindrical member for axial movement therein, said plate incorporating a plurality of piercing elements mounted thereto, said piercing elements incorporating passageways formed therein and positioned for cooperating engagement with the sealing means of the holding chamber, whereby movement of said plate into engagement with the holding chamber causes said piercing elements to penetrate the sealing means thereof for enabling the second component to be transferred through the piercing elements into the cylindrical member,
whereby the components forming the bone cement are separately stored and thoroughly intermixed in a single housing for forming the desired bone cement, while also being able to be dispensed to the desired site from said housing.

17. The bone cement mixing and dispensing system defined in claim 16, wherein the holding chamber incorporates a central passageway formed therein which cooperates with the side wall member to define a retaining zone therebetween for the second component, said retaining zone being sealingly established by an end cap extending between the side wall member and the passageway at the first end of the holding chamber and said sealing means extending between the side wall member in the passageway at the second end of the holding chamber.

18. The bone cement mixing and dispensing system defined in claim 17, wherein said holding chamber further comprises valve means formed in the end cap and constructed for enabling the sealed holding chamber to be exposed to ambient conditions, thereby enabling the second components of the bone cement retained a therein to freely flow through the passageways of the piercing elements.

19. The bone cement mixing and dispensing system defined in claim 18, wherein each of the arm/blade members of the mixing element are further defined as comprising a truncated triangular shape intersecting with each other at the center of the support base/ring, thereby further enhancing the thorough stirring and intermixing of the components forming the bone cement.

20. The bone cement mixing and dispensing system defined in claim 18, wherein the post member of the mixing element is dimensioned for sealingly closing the central passageway of the holding chamber for preventing mixed bone cement to enter the passageway during the axial movement of the holding chamber through the mixing vessel.
